(19) United States
(12) Patent Application Publication
(10) Pub. No.: US 2003/0148682 A1
(43) Pub. Date: Aug. 7, 2003

(54) Sheet textile structure for the substructure of printers' blankets

(76) Inventors: Klaus Fussmann, Bischberg (DE); Brigitte Hiemenz, Bischberg (DE); Peter Klenner, Geisfeld (DE)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/291,802

(22) Filed: Nov. 12, 2002

Related U.S. Application Data
(63) Continuation of application No. PCT/EP01/05224, filed on May 8, 2001.

(30) Foreign Application Priority Data
May 9, 2000 (DE) 10022471.7

(51) Int. Cl. B32B 9/04; B32B 27/02; B32B 5/02

(52) U.S. Cl. 442/65; 442/103; 442/286; 442/153; 442/154; 442/167; 427/385.5

(57) ABSTRACT

The invention relates to a textile fabric for the base structure of printing blankets, which is characterised in that the fibres of the fabric are fixed by means of an organic film-forming polymer, which reduces the elastic properties of the fibre material and which is formed by treatment of the fibres with an aqueous solution, dispersion, emulsion or suspension of a polymer pre-cursor and subsequent cross-linking. The invention further relates to a method for the production of said textile fabric.

The present invention is aimed at a textile material that is suitable for use in the substructure of printers' blankets.

Printer' blankets are used as important functional components in various printing processes. The structure of such printer' blankets is preferably multi-layered in nature, whereby this is called for by the stringent physical requirements; it consists of different components. The substructure, which is a middle layer that responds in an elastic manner to compression (elasticity is a prerequisite during printing), and a cover layer can be designated as being essential here. The substructure in this regard usually consists of a laminated woven fabric to which a non-vulcanized rubber layer, or something similar, is attached. A single layer of woven fabric is located over this, and is covered over by means of a cover layer. The appended FIG. 1 shows a cross-section through such a printer's blanket.

The substructure is responsible for reinforcing the printer's blanket. Cotton fabric has been used for this up to now. Since high mechanical stressing requires that the extension of the woven fabric that is used be markedly reduced and the force/extension characteristics be tightly specified, the cotton has been pre-stretched to an extreme extent up to now, namely in such a way that extension characteristics of <1% at 500 N have been achieved (breadth of the crosspiece of the test specimen: 50 mm in the tensile testing machine). Such drawing processes are accompanied by a marked loss in breadth that can amount to up to 20%, or even 30%, depending on the woven fabric. This means a corresponding loss of end product based on the surface area of the starting material. In addition, the fiber materials that are used in the woven fabric tend to deform as a result of the ongoing printing process. A loss of thickness takes place in the range of a few hundredths of a millimeter (so-called sinking), and this has a negative effect on print quality.

After drawing, the cotton fabric has to be calendared in order to make it uniform in thickness, and to reduce this thickness in a controlled manner if required. However, the calendaring effect persists for only a short time since the woven fabric tends to recover from the mechanically stored forces arising from the drawing and calendaring processes. Up to now, it has therefore been necessary to harmonize and couple this phase of the operation and the further manufacture of the printer's blanket with respect to time. Manufacture of the woven fabric, which is envisaged for the substructure of printer' blankets, was not therefore possible in stockpile quantities. In order to counteract the restoration effect, moreover, calendering to a lesser thickness than the required final thickness has also been carried out up to now. As a result of this, possible damage to the fibers had to be tolerated, and this is undesirable.

The problem for the present invention is to avoid the disadvantages of the prior art, and to make available surface textile structures, especially woven fabrics, that are suitable as, or for, the substructure of printer' blankets.

The problem is solved by making available sheet textile structures whose fibers have been strengthened by means of an organic film-forming polymer that reduces the elastic properties of the fiber material. The polymer can be formed by applying to the fibers an aqueous solution, dispersion, emulsion, or suspension of a precursor of the polymer, together with subsequent cross-linking. Preferred embodiments are indicated in Claims 2 through 10. In addition, a process is proposed for the manufacture of these sheet textile structures.

It has been possible to show that the sheet textile structures remain, in essence, dimensionally stable during the treatment in accordance with the invention. Following the cross-linking of the polymers, a chemically strengthened woven fabric is produced which, in terms of force/extension characteristics and improved fiber stability, satisfies the requirements for further processing to give a printer's blanket.

The fibers of the sheet textile structure can be joined together in any suitable manner. However, use is preferably made of a woven fabric, although textiles can, of course, be used that have been joined in other ways, such as knitted products, felts, or similar materials.

The material of which the fibers consist can also be selected freely, whereby cotton is very suitable because of its ready availability and its other fiber properties. However, use can also be made of other fiber materials if required, e.g. those on the basis of cellulose or synthetic fibers, whereby it is to be ensured that the temperature that might be required for cross-linking the polymer will be tolerated by the textile material.

Prior to treatment with the polymer, the textile material is optionally pre-treated in a suitable manner, e.g. it is washed in order to remove dirt or dust or even process materials or coatings that were used during its manufacture such as size, or similar materials.

The expression “organic film-forming polymer that reduces the elastic properties of the fiber material” is to encompass those polymers, which, optionally after cross-linking, are capable of forming a hard film and of effectively counteracting the property of the fibers of becoming extended under tension. Polymers with a glass transition temperature T_{g}>0° C. are suitable for this purpose, especially those with T_{g}>10° C., and especially preferably polymers with T_{g}>20° C. In addition, the polymers that are usable in accordance with the invention should be capable of being applied to the fibers from aqueous systems since the sheet textile structure for the substructure of printer' blankets is to be manufactured without organic solvents in order to avoid environmental pollution in this connection, and also to avoid the use of the extra installations that are necessary for this purpose, such as suctional exhaust systems and similar devices. Polymer dispersions of polyacrylates, polymethacrylates, or similar substances, which are capable of being cross-linked, are especially suitable for the present invention, whereby these confer a high degree of hardness and rigidity after cross-linking the fibers. Naturally, polymers that comprise one monomer, or various monomers, can also be used for the polymers of the present invention, whereby use can be made of both homopolymers and copolymers, either on their own or in the form of mixtures.

The polymer is preferably applied to the fibers of the sheet textile structure in such a way that it penetrates into the fibers and ensheathes them as completely as possible. They acquire high rigidity as a result of the fact that the fibers, yarn pores, and possibly the woven fabric pores are filled and coated with the polymers. The extension potential, which results from the fibers, yarn rotation, and possibly the settling down of the woven fabric, is hereby frozen in permanently. In a first embodiment of the invention, use is made of a relatively low viscosity recipe of the polymer or of precursors of the polymer, such as monomers or pre-polymers, in order to soak the fibers. For example, recipes are suitable that have a proportion of solids or polymer (precursors) that amounts to approximately 10-60% by weight, or preferably approximately 15-40% by weight, or much more preferably approximately 20-30% by weight, and quite especially preferably approximately 25% by weight. Such recipes are commercially obtainable in ready-to-use form. The addition of a wetting agent is also advantageous since better penetration of the fibers is produced as a result. The wetting agent can be present in a quantity of a few percent, for example 2% by weight. The solution, dispersion, emulsion, or suspension of the polymer optionally contains suitable additives such as polymerization initiators for the subsequent cross-linking reaction, and/or other auxiliary materials. The remainder is solvent, preferably water, either substantially or exclusively.

The recipe can be applied using a foulard finishing machine of the mangle type. After applying the mixture, the material is dried, preferably in a tenter, e.g. at elevated temperatures.

If no additional operational phase is to take place in terms of application, then the polymer is cross-linked using conventional processes, for example thermally or via the action of light.

Alternatively, the textile material that is to be treated is treated with a solution, dispersion, emulsion, or suspension of the polymer that is more highly viscous than that of the recipe that was mentioned above as being preferred and with which penetration of the fibers was achieved. The treatment takes place here via spreading onto one side, or onto both sides, of the sheet structure, which in turn, can be clamped in a tenter for this purpose. In order to do this, use is made of a recipe with a higher proportion of polymer. Thus the proportion of polymer can amount to e.g. 20-80% by weight, or preferably 25-40% by weight, and quite especially preferably approximately 35% by weight. In addition, fillers can be used such as talcum. Moreover, it is possible to increase the viscosity of this recipe by adding a thickener. The recipe advantageously contains an antifoaming agent or de-aerating agent as well. This treatment preferably takes place on one side.

The recipe can be applied to the woven fabric by means of the air knife process, for example. The material is then dried, preferably with increasing temperatures. If thermal cross-linking is envisaged, then the drying process can be coupled to the cross-linking process by adjusting the temperature slowly or, respectively, little by little up to the required final value.

In an especially preferred form of embodiment of the present invention, the processes that were designated above for applying the polymer are both utilized sequentially, whereby the lower viscosity recipe is preferably applied first. The textile material is then dried, but the polymer is not yet cross-linked. The cross-linking of the entire polymer material can take place after drying the higher viscosity polymer recipe that was applied in a single-sided or two-sided manner. In the case of this process variant, treatment on only one side with the higher viscosity solution, dispersion, emulsion, or suspension of the polymer is frequently especially favorable.

Since it is desirable that a large portion of the recipe should penetrate into the pores of the yarns or of the woven fabric, the type of application as described above with a foulard finishing machine of the mangle type and air knife is especially preferred.

The sheet textile structure, which is manufactured as described above, can be calendered if required, e.g. in order to adjust or reduce its thickness to a desired value.

The textile material, which is treated in accordance with the invention, is more stable from the inside to the outside than textiles, which have been treated conventionally, for the substructure of printers blankets. This might be due to the fact that the pores in the woven fabric of the material in accordance with the invention have been filled completely or to significant extents. As a result, its mechanical ability to withstand stress is improved, e.g. in regard to sinking.

As already mentioned above, use is usually made of a laminated woven fabric for the substructure of printer' blankets. Up to now, laminating usually took place with the help of a rubber solution in an organic solvent. As is known, operational phases with use being made of organic solvents require special precautionary measures, such as a separate exhaust air conveyance system along with subsequent incineration of the liquid that is generated in the form of waste material. As a result of the present invention, it is now possible to eliminate lamination via a rubber solution, and to replace it with aqueous systems. This is because the textile material, which has been treated in accordance with the invention, can be coated and laminated using conventional laminating machines, e.g. using aqueous laminating adhesives. This might be due to the fact that the applied polymer acts in an adhesion-mediating manner during additional coating processes.

As experiments by the applicant have shown, the sheet textile structure in accordance with the invention can be calendered without its thickness, which is adjusted in this way, changing subsequently, even over extended periods of time and/or during additional processing steps. Thus the calendering effect is a permanent effect in the case of substructures, which are in accordance with the invention, for printer' blankets. Even a subsequent experimental steaming process, which promotes the swelling of the fibers and which should therefore lead to an increase in thickness, has no effect on the thickness that is achieved via calendering. A series of advantages arise as a result of this. Thus calendering can take place independently of the location and point in time of the manufacture of the printer' blankets, and also in larger lot sizes, and the final thickness is capable of being planned more exactly, and unnecessary damage to the fibers is avoided.

The invention will be elucidated in more detail below by means of examples.

### EXAMPLE 1

Manufacture of a woven fabric that is suitable for the substructure for a printer's blanket. Use was made of a woven fabric that is conventionally used, after mechanical drawing, for the manufacture of printer' blankets. This was 100% Egyptian cotton, super-combed with the following adjustment: 19.5/21.0 28×2/28.0 cm/Nm; from spliced yam, knot-free, manually cleaned and rolled.

The woven fabric breadth amounted to 262 cm. //Translator: the somewhat unusual lay-out of these numbers, etc. is based on that in the original text//

The woven fabric was washed on a Brugman washing machine of the broad type. As a consequence of shrinkage on boiling that is called for in the case of cotton, the breadth decreased to 249 cm. The woven fabric, which had been treated in this way, was treated on a Bruckner finishing tenter using the following recipe:

| | | |
|---|---|---|
| 50 | parts of Atepol B-A 75 | from Dr. Th, Böhne [a firm] |
| 50 | parts of water | |
| 2 | parts of Lavotan DSU | Chem. Fabrik Tilbingen [a firm] |

Atepol B-A75 has a glass transition temperature of 30° C.

The preparation was applied using a foulard finishing machine of the mangle type with a bath liquor uptake of 105%, and then dried at 120° C. in a tenter.

Coating on one side then took place in an additional operational phase using the following recipe:

| | | |
|---|---|---|
| 10 | parts of Schaumex B-ES | from Dr. Th. Böhne [a firm] |
| 100 | parts of Atepol B-A 75 | Dr. Th. Böhne [a firm] |
| 20 | parts of talcum | |
| 10 | parts of water | |
| 1.2 | parts of 25% ammonia solution | |
| 5 | parts of BOL thickener | Dr. Th. Böhne [a firm] |

The preparation was applied to one side of the woven fabric using the air knife process. The wet coating weight amounted to 55 g/square meter. The temperature regimen in the tenter was ascendent, namely 120/130/1401150/150/150° C. until the cross-linking temperature of 150° C. had been attained.

The loss in breadth as a result of the treatment amounted, in total, to approximately 7.8%.

### EXAMPLE 2

Calendering a woven fabric in accordance with the invention.

A woven fabric, which had been manufactured as in Example 1, with an initial thickness of 0.40 mm, was calendered to a thickness of 0.34 mm. The thickness value remained stable at 0.34 mm following a re-rolling process. A sample of this product was steamed in a tension-free manner, whereby the thickness of 0.34 mm did not change. The specified maximum thickness of this woven fabric is 0.35 mm.

The two examples show that the use of film-forming polymers with a glass transition temperature of 30° C. leads to excellent results.

### Reference Example

Calendering a cotton fabric that had been used up to now for printer' blankets.

Pre-drawn cotton fabric with an initial thickness of 0.30 mm was calendered to 0.23 mm using a linear pressure of 250 N/mm. The thickness rebounded to 0.28 mm merely as a result of subsequent re-rolling, and this was 0.03 mm above the specified maximum thickness. Because of the lot size, the calendering process had to be repeated immediately prior to further processing.

What is claimed is:

1. Sheet textile structure for the substructure of printer' blankets, characterized by the feature that the fibers of the structure have been strengthened with an organic film-forming polymer that reduces the elastic properties of the fiber material, whereby this polymer can be formed by applying to the fibers an aqueous solution, dispersion, emulsion, or suspension of a precursor of the polymer together with subsequent cross-linking.

2. Sheet textile structure in accordance with claim 1, characterized by the feature that the polymer possesses a glass transition temperature of >20° C.

3. Sheet textile structure in accordance with claim 1 or 2, characterized by the feature that the fibers have been ensheathed and/or filled with the organic polymer and, in addition, a further layer, which comprises the same or another organic film-forming polymer without elastic properties, has been applied to one or both sides of the structure.

4. Sheet textile structure in accordance with one of the preceding claims, characterized by the feature that the polymer contains poly(meth)acrylate groups.

5. Sheet textile structure in accordance with claim 3 or 4, characterized by the feature that the polymer, which has been applied to one or both sides of the structure, is present in the form of a mixture along with a filler, preferably talcum, and/or a thickener, especially polymerized acrylic acid.

6. Sheet textile structure in accordance with one of the preceding claims, characterized by the feature that the polymer, with which the fibers have been ensheathed and/or filled, is present in a quantity of 10-50% by weight, or preferably 20-30% by weight, based on the weight of the untreated fibers.

7. Sheet textile structure in accordance with one of the claims 2 through 6, characterized by the feature that a polymer layer has been applied to one side only of the structure, and this layer is present in a quantity of 10-100 g/m , or preferably 15-30 g/m

8. Sheet textile structure in accordance with one of the preceding claims, characterized by the feature that it is a woven fabric.

9. Sheet textile structure in accordance with one of the preceding claims, characterized by the feature that the fibers of the structure are cotton fibers, cellulose fibers, or synthetic fibers, or mixed fibers that contain such fibers as components.

10. Sheet textile structure in accordance with one of the preceding claims, characterized by the feature that it comprises two fiber layers that have been joined together with the help of an aqueous laminating adhesive.

11. Process for the manufacture of a sheet textile structure in accordance with one of the claims 1 through 10, characterized by the feature that
(a) the fibers of the structure are brought into contact with an aqueous solution, dispersion, emulsion, or suspension that contains a film-forming organic polymer, which is capable of being cross-linked, and/or its precursor(s) and optionally a wetting agent, whereby, in the cross-linked state, the polymer reduces the elastic properties of the fiber material,
(b) the structure is dried at a temperature between room temperature and a temperature below the cross-linking temperature of the polymer,
(c) if necessary, [fibers of the structure] are brought into contact, on one side of the sheet structure, with an aqueous solution, dispersion, emulsion, or suspension that contains the same or another film-forming organic polymer, which is capable of being cross-linked, or its precursors, together with a filler and/or a thickener and optionally an antifoaming agent, and
(d) the structure is optionally then dried, or partially dried, at a temperature between room temperature and a temperature below the cross-linking temperature of the polymer, after which
(e) the polymer and/or its precursor(s) is/are cross-linked.

12. Process in accordance with claim 11, characterized by the feature that, after cross-linking the polymer and/or its precursors, the structure is transported over one or more calendering rollers.

13. Process in accordance with claim 11 or 12 in which the solution, dispersion, emulsion, or suspension in step (a) contains 10-60% by weight, or preferably 20-30% by weight, of polymer, and 0 to 5% by weight of wetting agent, and/or the solution, dispersion, emulsion, or suspension in step (b) contains 20-80% by weight, or preferably 25-40%, by weight of polymer and/or its precursor, 0-10% by weight of antifoaming agent, 0-20% by weight of talcum, and 0-5% by weight of thickener.

14. Process for the manufacture of a sheet textile structure in accordance with one of the claims 1 through 10, characterized by the feature that two layers comprising fibers, which have been treated in accordance with one of the claims 11 through 13, are laminated with the help of an aqueous laminating agents.
